(19) United States
(12) Patent Application Publication
(10) Pub. No.: US 2002/0069194 A1
(43) Pub. Date: Jun. 6, 2002

(54) Client based online content meta search

(76) Inventor: Benjamin Jon Robbins, Lynnwood, WA (US)

Correspondence Address: COLUMBIA IP LAW GROUP, PC, 10260 SW GREENBURG ROAD, SUITE 820, PORTLAND, OR, 97223, US

(21) Appl. No.: 09/731,890

(22) Filed: Dec. 6, 2000

(51) Int. Cl. G06F 7/00

(52) U.S. Cl. 707/3

(57) ABSTRACT

A client based meta search service server is equipped to pre-provide each of a number of client computers with a meta search function, and a number of complementary search query and search result processing templates for a number of search engines. During operation, each of the client computers would use the meta search function and selected ones of the search query templates to concurrently and separately submit a number of search queries to the search engines. The client computer would further use corresponding ones of the search result processing templates to process the search results separately returned by the search engines to extract selected portions of the returned search results for display. As a result, the client computers may operationally conduct meta searches on their own without operational dependency on other servers, including the service server.

### BACKGROUND OF THE INVENTION

1. Field of the Invention

The present invention relates to the field of data processing. More specifically, the present invention relates to the art for online content searching.

2. Background Information

FIG. 1 illustrates online content meta search under the prior art. As illustrated, prior art online content meta search, i.e. searching for certain online contents using multiple search engines at the same time, is server based. Under the prior art, a client computer, such as client computer 102, interested in doing such online content meta search would connect itself to a meta search site, such as meta search site 106, using a generic client agent, such as browser 104, using e.g., a HTTP connection signaled in accordance with TCP/IP. A user of client computer 102 would specify one or more search criteria and provide the specified search criteria to meta search site 106. Meta search site 106, having knowledge of the manner search queries of the various search engines, such as search engines 112a-112n, are formed, would in turn construct the appropriate search queries, and submit them to search engines I 12a-112n.

In response, inquired ones of search engines 112a-112n would search their respective databases, directories, and/or repositories, and return their search results to meta search site 106. Typically, the search results are location identifiers (such as URLs) identifying where contents satisfying the search criteria may be obtained. As the content location identifying search results are returned from the various inquired search engines, meta search site 106 would concatenate the returned search results, and return them as a single concatenated set of search results to browser 104. If desired, a user may select one of the returned content location identifying search results to retrieve the identified content, e.g. from identified content site 116. In response, browser 104 would open a new connection to content site 116 and retrieve the desired content (the prior connection to meta search site 106 having been terminated upon return of the search results).

The prior art online content meta search suffers from at least the following disadvantages. First, partly because each meta search site may have to serve up to millions of concurrent client computers and partly because of technical infeasibility, so as described earlier, the returned search results of the various search engines are merely just appended together (by the meta search site), with little or no processing to enhance their usability (except inserting revenue generating advertisements that help to pay for the services offered by the meta search site) before forwarding them to the requesting clients. Thus, users of client computers 102 typically have to scroll through the returned search results of one search engine before the users can see the returned search results of another search engine. In other words, the returned search results are not presented to the users in the order of relevance. The returned search results are ordered only among the search results of the corresponding search engines. As a result, the most relevant search result is often buried in the middle of the concatenated search results, even if it was returned as one of the most relevant search results by a particular search engine. Further, very often, at least some of the search results returned by the various search engines are the same, resulting in numerous duplicate entries in the concatenated search results. The duplicate entries further serve to obfuscate the search results, making it even more difficult for the users to identify the most relevant returned search results. Additionally, the returned search results cannot be reordered or otherwise manipulated by the users of the client computers. Different queries must be submitted to achieve a different ordering or organization of the search results. Similarly, the lack of post retrieval usability enhancement processing, such as highlighting of key search terms, also contributes to their obfuscation.

Thus, an improved approach to online meta search is desired.

### SUMMARY OF THE INVENTION

A client based meta search service server is equipped to pre-provide each of a number of client computers with a meta search function, and a number of complementary search query and search results processing templates for a number of search engines. During operation, each of the client computers would use the pre-provisioned meta search function and selected ones of the search query templates to concurrently and separately submit a number of search queries to the search engines. The client computer would further use corresponding ones of the search results processing templates to process the search results separately returned by the search engines to extract selected portions of the returned search results for display. As a result, the client computers may operationally conduct meta searches on their own without operational dependency on other servers, including the service server.

In one embodiment, each of the client computers is further equipped by the client based meta search service server to dynamically and incrementally merge the extracted portions of the returned search results into a composite set of search results with at least reduced number of duplicates, and compute a composite relevance value for each of the search results of the composite set, as the search results are returned. The composite set of search results are displayed in accordance with the computed composite relevance values, thereby improving the usability of the returned search results.

In one embodiment, each computation of the composite relevance values includes assigning weights to the search result based at least on the relevant weights assigned to the incidences of the search result by the returning search engines, the number of search engines returning incidences of the search result, the relative positions of the incidences of the search result in the returned search result sets of the search engines, and the number of exact occurrences of the key search terms.

In one embodiment, the search results are location identifications of contents satisfying search criteria specified for the search queries, and the client computers are further equipped to retrieve selected ones of the contents in response to user selections of the returned location identifications. Further, the client computers are equipped to process the retrieved contents in a manner, such that additional usability enhancement processing, such as highlighting occurrences of the search criteria in the retrieved contents, may be performed.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates prior art online content meta search;

FIGS. 2-3 illustrate a network view and a method view of the client based online content meta search of the present invention, in accordance with one embodiment;

FIG. 4 illustrates the concept of category and search engine correspondence;

FIG. 5 illustrates a search engine template of the present invention, in accordance with one embodiment;

FIG. 6 illustrates an user interface for specifying search criteria for a selected search category, in accordance with one embodiment;

FIG. 7 illustrates the operational flow of the relevant aspects of the client browser meta search extension of FIG. 2, in accordance with one embodiment;

FIG. 8 illustrates an user interface for displaying merged search results, in accordance with one embodiment;

FIG. 9 illustrates the operational flow of the relevant aspects of the client browser meta search extension of FIG. 2 for forming the merged search results, in accordance with one embodiment;

FIG. 10 illustrates an example data organization for forming the merged search results, in accordance with one embodiment;

FIG. 11 illustrates the operational flow of the relevant aspects of the client browser meta search extension of FIG. 2 for retrieving contents and preprocessing retrieved contents, in accordance with one embodiment; and

FIG. 12 illustrates an example computer system suitable for use to practice the present invention, in accordance with one embodiment.

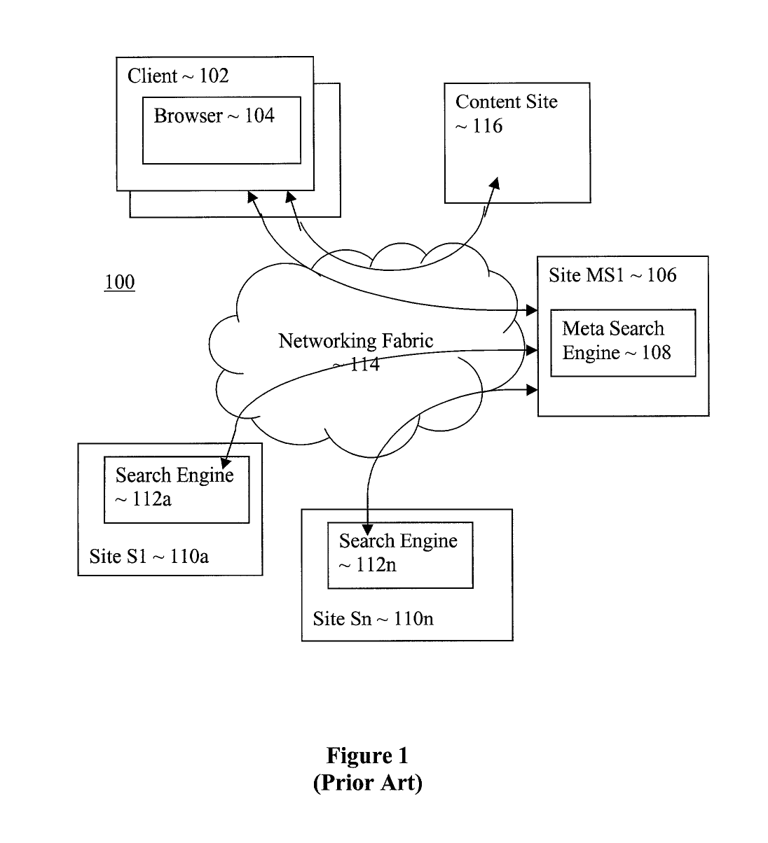

### DETAILED DESCRIPTION OF THE INVENTION

In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will also be apparent to one skilled in the art that the present invention may be practiced without the specific details. In other instances, well known features are omitted or simplified in order not to obscure the present invention.

Parts of the description will be presented in terms of operations performed by a processor based device, using terms such as data, tables, accepting, transmitting, merging, displaying, and the like, consistent with the manner commonly employed by those skilled in the art to convey the substance of their work to others skilled in the art. As well understood by those skilled in the art, the quantities take the form of electrical, magnetic, or optical signals capable of being stored, transferred, combined, and otherwise manipulated through mechanical and electrical components of the processor based device; and the term processor include microprocessors, micro-controllers, digital signal processors, and the like, that are standalone, adjunct or embedded.

Various operations will be described as multiple discrete steps in turn, in a manner that is most helpful in understanding the present invention, however, the order of description should not be construed as to imply that these operations are necessarily order dependent. In particular, these operations need not be performed in the order of presentation. Further, the description repeatedly uses the phrase “in one embodiment”, which ordinarily does not refer to the same embodiment, although it may.

### Overview

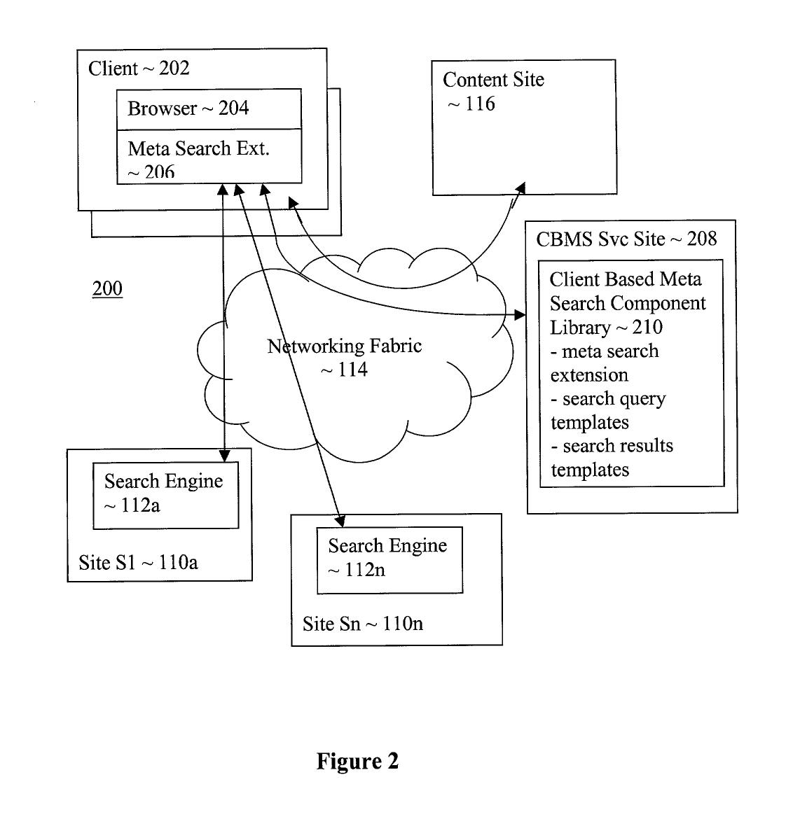

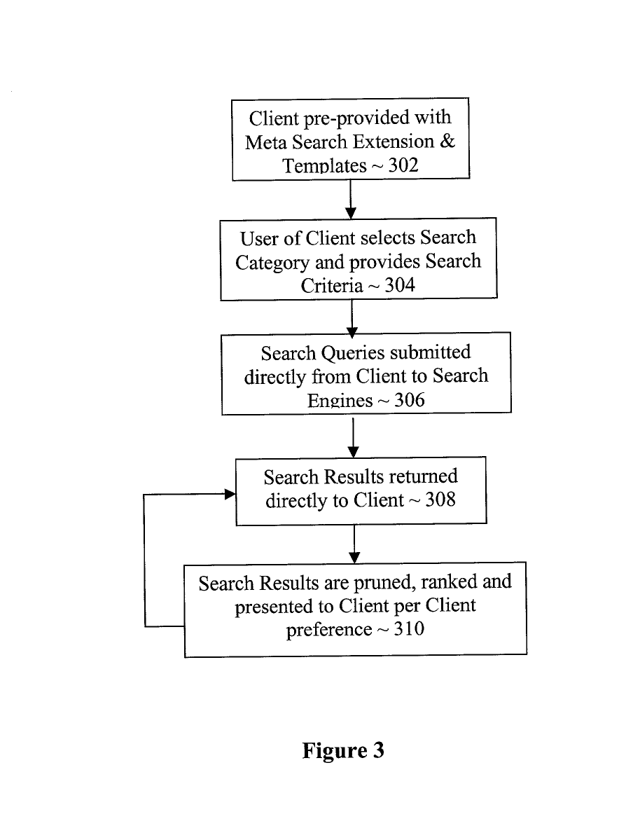

Referring now first to FIGS. 2-3, wherein two diagrams illustrating a network view and a method view of the present invention, in accordance with one embodiment, are shown. As illustrated, a server, such as server 208, is provided with a meta search function, a number of search query templates and a number of search results processing templates for use to pre-equip client computers to formulate search queries for a number of search engines, such as search engines 112a-112n, and process search results returned by the search engines on their own. For clarity, server 208 will be referred to as client based meta search (CBMS) service server. The meta search function, the search query templates and the search results processing templates are stored in meta search library 210 of CBMS service server 208 for download by authorized client computers 202. In alternate embodiments, the meta search function, the search query templates and the search results processing templates may be provided to eligible client computers 202 via alternate techniques, such as the employment of distribution medium like CDROM.

For ease of understanding, the present invention will be described with each searchable site, such as search sites 110a-110n, having “one” search engine 112a-112n, from the search query submitter's perspective. That is, for ease of understanding, search sites like Amazon_Books and Amazon_Records are considered to be “two” sites having corresponding search engines. Thus, unless specifically delineated, the terms “search site” and “search engine” are intended to be interchangeable. Of course, from the description to follow, as those skilled in the art would appreciate, the present invention may be practiced in substance with each search site have one or more externally distinguishable or undistinguishable search engines. That is, it is substantively immaterial whether sites like Amazon Books and Amazon Records are considered to be two sites, each with their corresponding search engine or one site with multiple search engines.

Continuing to refer to FIGS. 2-3, in accordance with the present invention, each of client computers 202 would pre-download the meta search function, the search query templates, and the search results processing templates from CBMS service server 208 (block 302), before conducting independent meta searches in accordance with the present invention. For the illustrated embodiment, meta search function is implemented as an extension 206 to browser 204. Meta search extension 206 would output its display to an auxiliary display pane “appended” to the main display pane of browser 204, advantageously making its operations appear to the user as an integral part of browser 204. The manner in which the extension is achieved is browser dependent. For examples, in the case of the Netscape browser, the extension may be effectuated through the well known plug-in approach, in the case of the Internet Explorer (IE) browser, the extension may be effectuated as additional COM objects to the IE browser (“container”), and so forth. In alternate embodiments, the meta search function may be implemented as an extension to other applications or as a standalone application.

During operation, each of client computers 202 would use meta search extension 206 and selected ones of the search query templates to formulate, and concurrently submit separate search queries to selected ones of search engines 212a-212b directly (blocks 304-306). In response, upon searching its databases, directories, and/or repositories, inquired search engines 212a-212n would return search results satisfying the search criteria to client computer 202 directly (block 308). As described earlier, often times, the returned search results are location identifiers (such as URLs) identifying where the search criteria satisfying contents may be retrieved. By virtue of the fact that the processing power of a client computer is primarily dedicated to servicing the needs of its local user, thus in accordance with the present invention, the processing power of client computer 202 is advantageously applied to further process the returned search results to enhance their usability (block 310).

That is, unlike the prior art, upon provisioned with the search criteria, the search queries are formulated on the client computer, and submitted out of the client computer, directly destined to the addressed search engines. Likewise, unlike the prior art, the search results are returned directly to the search query submitting client computer. [Recall under the prior art, the search criteria are provided to the meta search site, where the search queries are formulated and submitted. In turn, the search results are returned to the meta search site, concatenated, before returning to the client computer.] Most importantly, the returned search results are processed to enhance their usability for the users.

CBMS service server 208, client computers 202, and search engines 112a-112b are coupled to each other via networking fabric 114, which is intended to represent a broad range of private or public, wire line based or wireless, local or wide area networks known in the art, including but are not limited to e.g. the Internet. CBMS service server 208, client computers 202, and search engines 112a-112b may communicate with each other using any one of a number of messaging and communication protocols mutually supported by the parties. In one embodiment, the parties practice the present invention using the Hypertext Transmission Protocol (HTTP) in conjunction with the Telecommunication Control Protocol/Internet Protocol (TCP/IP).

Except for the teachings of the present invention incorporated in CBMS service server 208 and clients 202, server 208, clients 202 and search engines 112a-112n are intended to represent a broad range of these elements known in the art. Examples of search engines 112a-112n include but are not limited to well known search engines such as Yahoo, Alta Vista and the like, and e-commerce sites such as Amazon, Barnes & Nobles, and so forth. In other words, the present invention is advantageously designed to be transparent to existing search engines (i.e. without requiring modifications to any of the existing search engines). Similarly, any one of a number of well known servers, such as those available from Sun Microsystems of Menlo Park, Calif., and desktop or notebook computers or computing devices of other form factors, such as those available from Hewlett Packard of Palo Alto, Calif., may be used to practice the server and client aspects of the present invention. Accordingly, except for the teachings of the present invention incorporated in CBMS service server 208 and clients 202, the other elements will not be further described.

### Search Category and Search Engine Templates

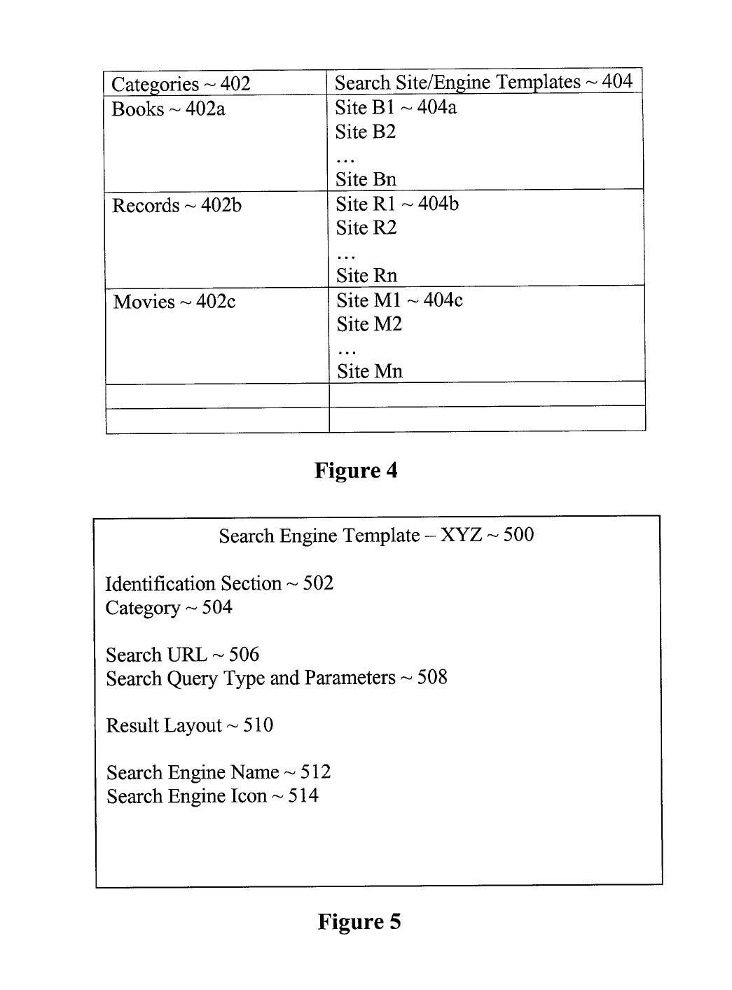

For the purpose of enhancing usability, the present invention contemplates correspondence between selected combinations of the search sites/engines (more specifically, their search query and search resulting processing templates) and search categories, to facilitate automatic application of search criteria entered by a user to multiple search sites/engines. FIG. 4 illustrates the contemplated correspondence, in accordance with one embodiment. As shown, meta search function, such as meta search extension 206 of FIG. 2, is designed to recognize a number of search categories 402. Examples of these search categories 402 include but are not limited to Books 402a, Records 402b, Movies 402c, and so forth. Corresponding to each search category 402 is a predetermined combination of search sites/engines, and therefore, their search query and search processing templates 404. For examples, search category “Book” 402a is predetermined to trigger submission of search queries to site/engine B1-Bn 404a (using their corresponding templates), whereas search category “Record” 402b is predetermined to trigger submission of search queries to site/engine R1-Rn 404b, and so forth. Of course, some of search sites/engines may be identical. For example, a general search site such as Yahoo may be included as part of the designated search sites/engines of multiple search categories.

The number and the precise nature of the search categories, as well as the number and the precise nature of the combinations of the search sites/engines, and their correspondence to the search categories are implementation dependent. Different implementations may employ different number as well as different search categories, combinations of search sites/engines and correspondence. Search categories 402 preferably are provided by CBMS service server 208, but may be customized by a user by e.g. reducing or “hiding” some of the search categories. The user interface and process for facilitating such customization may be accomplished using any one of a number of techniques known in the art. Further, the correspondence may be implemented using any one of a number of data structures known in the art, e.g. a table.

FIG. 5 illustrates a search engine template 500, in accordance with one embodiment. As shown, the embodiment is a composite embodiment including both the search query template and the search results processing template, defining both aspects at the same time. Of course, in alternate embodiments, the present invention may be practiced with the search query templates and the search results processing templates organized separately (i.e. separately defining the two aspects).

For the illustrated combined embodiment, combined template 500 includes an identification section 502 identifying the template. The identification information may include for example a name of the template, the search site/engine the template is affiliated with, its version level, last modified date, and so forth. In addition, example template 500 also includes a category section 504 specifying a search category with which the template is affiliated.

Further, example template 500 includes sections 506 and 508 specifying the details for forming a search query for the affiliated search site/engine. For the illustrated embodiment, sections 506-508 include the URL to be used 506, and the syntax for specifying the query and the query parameters 508.

Further, for the embodiment, template 500 includes layout details 510 for reading or processing the search results returned by the affiliated search site/engine. In one embodiment, the returned search results are encoded using the HyperText Markup Language (HTML), and layout details 510 specify the line numbers, the associated tags, and so forth, through which the substantive search results may be located.

Finally, for the illustrated embodiment, template 500 includes the search site/engine name 512 and its icon 514 to be used when displaying the search results returned by the search site/engine (to inform the user the source of the displayed search result). In one embodiment, icon specification 514 is a bit map of the icon itself. In alternate embodiments, icon specification 514 is a file identifier identifying a file containing the details of the icon to be used.

### Specification of Search Criteria and Submission of Search Queries

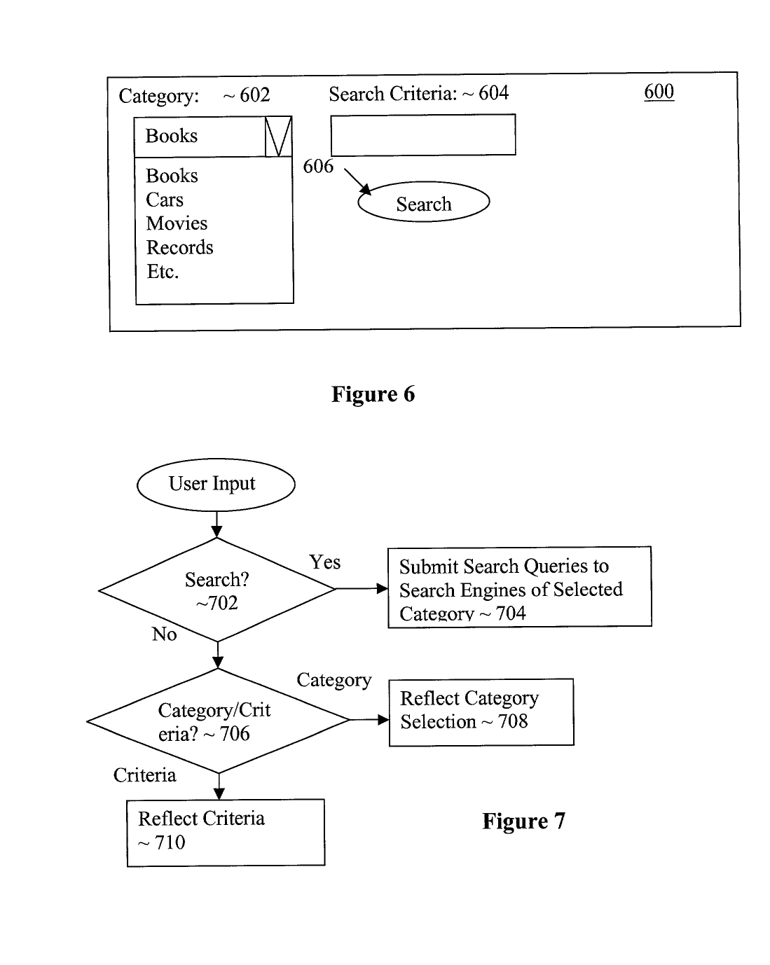

FIG. 6 illustrates an user interface suitable for use to specify the search criteria of an online content meta search on a client computer, and launch a number of search queries directly from the client computer separately destined for a number of search sites/engines. As illustrated, for the embodiment, user interface 600 includes a category drop down list 602 for a user to select a search category, such as books, records, movies and so forth. User interface 600 also includes search criteria input field 604 for a user to enter a number of search criteria for the selected search category 602. Finally, user interface 600 includes a “search” button 606 for triggering a number of search queries having the entered search criteria to be generated on the host client computer, and directly submitted to the search sites/engines corresponding to the selected search category. Of course, user interface 600 may include other features/functions, which are omitted for ease of understanding. In one embodiment, meta search extension 206 supports user interface 600 displaying it on the earlier described auxiliary display pane appended to the main display pane of browser 204.

FIG. 7 illustrates the operational flow of the relevant aspects of meta search extension 206 of FIG. 2 in support of the user interface 600, in accordance with one embodiment. As illustrated, upon receipt of user inputs, meta search extension 206 first determines if the input is associated with the user selecting the “search” button, block 702. If so, meta search extension 206 generates the search queries for the corresponding search sites/engines using the pre-provisioned search query templates, and directly submits the generated search queries to the corresponding search sites/engines, block 704. In one embodiment, meta search extension 206 launches a number of concurrently executing search query processes, one each for the corresponding search engines, using the corresponding search query templates.

On the other hand, if the input is not associated with the selection of the “search” button, meta search extension 206 further determines if the input is associated with user interaction with the category drop down list or with the search criteria specification field. If it is the former, meta search extension 206 changes the display of the category drop down list to reflect the user's interaction with the list, e.g. echoing a different search category in the selected search category field, block 708. On the other hand, if it is the latter, meta search extension 206 changes the display of the search criteria field to reflect the user's interaction with the search criteria field, e.g. echoing the search criteria entered, block 710.

Thus, under the present invention, a meta search for online content may be easily launched by a user, and submitted to a number of search engines corresponding to the user's selected search category in parallel, directly from a client computer (without operational dependency on other servers, including service server 208).

### Extracting and Enhancing Presentation of the Search Results

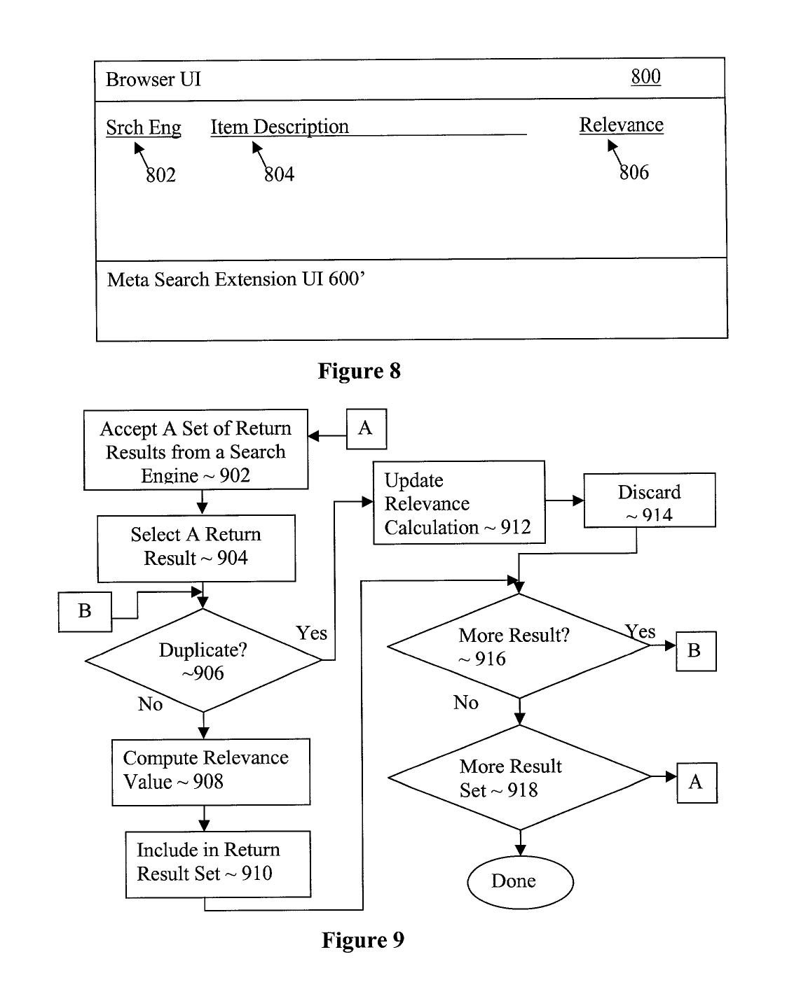

FIG. 8 illustrates a display for displaying the search results returned by the corresponding search engines, in accordance with one embodiment. As illustrated, display 800 includes item description column 804 for listing the returned search results. In one embodiment, the listed returned search results are “pruned” search results. In other words, unlike the prior art, the returned search results are advantageously pre-processed prior to their display. More specifically, the returned search results are merged, with certain discernable duplicate returned search results discarded.

For the illustrated embodiment, display 800 also includes a search engine column 802 for displaying the identities of the search engines returning the search results listed. Further, display 800 also includes relevance column 806 for displaying the corresponding relevance values of the search results listed. In one embodiment, each of the relevance values is a composite value computed in accordance with a number of heuristic factors (to be described more fully below), and the search results are listed in accordance with the computed composite relevance values. In one embodiment, meta search extension 206 supports display 800 outputting it on the earlier described auxiliary display pane appended to the main display pane of browser 204.

FIG. 9 illustrates the operational flow of the relevant aspects of the meta search extension 206 of FIG. 2, in support of accepting and processing the returned search results to enhance their usability, in accordance with one embodiment. As illustrated, the process starts with meta search extension 206 accepting a set of the returned search results (e.g. from one of the earlier described search query processes), block 902.

For each set of returned search results, meta search extension 206 would examine each returned search result, block 904, determining if the search result being examined is new, or it has already been previously returned by another search engine, i.e. a duplicate, block 906. In one embodiment, the returned search results are content location identifiers of the search criteria satisfying contents, expressed as URLs, the “duplicate” determination is made by comparing the URLs of the returned search results. If the search result being examined is deemed not a duplicate, meta search extension 206 would compute an initial composite relevance value for the search result, and include the search result as part of the merged search results set displayed for the user, blocks 908-910. In one embodiment, the “non-duplicate” search results are included in accordance with the computed composite relevance values. On the other hand, if the search result is deemed to be a duplicate, meta search extension 206 would merely update the composite relevance value, and discard the duplicate search results, blocks 912-914.

Upon examining each returned search result of a returned search result set from a search engine, regardless of whether the examined search result is a new or a duplicate search result, meta search extension 206 would determine if there are additional search results of the returned search result set remain to be examined, block 916. If so, the process continues back at block 906. If not, meta search extension 206 determines if there are additional search result sets have also been returned and remain to be processed, block 918. If so, the process continues back at block 902. If not, meta search extension 206 awaits the return of the next search result set before continuing back at block 902. Eventually, all search result sets would be returned and processed.

Thus, under the present invention, as a result of the advantageous dynamic merging and display of the returned search results, as soon as they are received, a user is provided with the search results in a much more expedited manner. Further, as a result of the advantageous pruning of discernable duplicate entries, and the presentation of the “non-duplicate” entries in the order of their corresponding computing composite relevance values, it is a lot easier for a user to locate the more relevant search results.

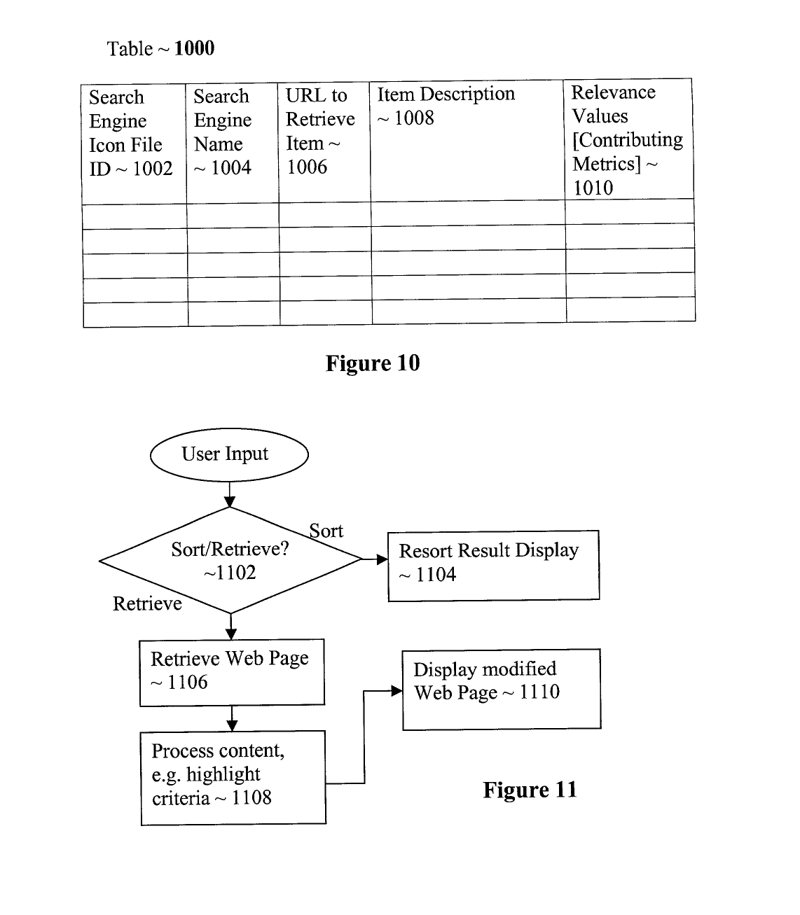

FIG. 10 illustrates a temporary data structure suitable for use to generate the composite returned search result set, including the search results' composite relevance values, in accordance with one embodiment. As illustrated, temporary data structure 1000 is a table having column 1008 for storing the “pruned” returned search results. In one embodiment, the search results are location identifiers (such as URLs) identifying where the search criteria satisfying contents may be retrieved, table 1000 further includes column 1006 for storing the location identifiers for retrieving the search criteria satisfying contents. In one embodiment, the location identifiers are not displayed, however, in alternate embodiments, they may be displayed.

For the illustrated embodiment, table 1000 further includes columns 1002 and 1004 for storing the search engine icon file identifiers and the search engine names for the search engines returning the search results. In one embodiment, the icon file identifier and search engine name of the first search engine returning the search result is stored. Icon file identifier and search engine name of subsequent search engine returning duplicate copies of the search result are discarded. In alternate embodiments, other approaches to selecting the search engine to be identified as the source of a search result may be employed instead.

Finally, for the illustrated embodiment, table 1000 includes a number of columns, columns 1010, for storing the composite relevance values, and the contributing metrics or heuristic factors employed to compute the composite relevance values. In one embodiment, the contributing metrics or heuristic factors include the relevant weights given to the search result by the returning search engine, the number of search engines returning the search result, the relative positions the incidences of the search result occupy in the respective returned search result sets, the number of exact occurrences of the search criteria (i.e. exact occurrences of the key search terms). These metrics are accumulated as the search results of the various search results sets are examined. In one embodiment, the determination of the number of exact occurrences of the search criteria is determined as part of the composite relevance value computation process. In alternate embodiments, more or less metrics/heuristic factors may be employed instead.

In one embodiment, each of the composite relevance values is computed by summing the weights assigned by meta search extension 206 to the earlier described metrics. In one embodiment, meta search extension 206 assigns an amount of weight that is directly proportional to the sum of the relevant weights assigned by the returning search engines, the number of search engines returning the search result and the number of exact occurrences of the key search terms, and an amount of weight inversely proportional to the sum of the positions occupied by the incidences of the search results in the respective search result sets. That is, a search result with two incidences occurring in the “earlier” (or numerically lower) more relevant positions of two return search result sets will be assigned greater weights than a search result with two incidences occurring in the “later” (numerically higher) less relevant positions of two return search result sets.

The exact weights to be employed for each of the metrics or heuristic factors may be empirically determined, and may vary from one implementation to another.

### Retrieving Selected Satisfying Contents and Enhancing Usability of the Retrieved Contents

FIG. 11 illustrates the operational flow of the relevant aspects of meta search extension 206 in support of retrieving search criteria satisfying contents corresponding to a selected returned location identifier, and processing the retrieve contents to enhance their usability, in accordance with one embodiment. As illustrated, upon presenting the composite search results e.g. in the example format of FIG. 8, meta search extension 206 awaits user interactions with the presented search results. Upon receipt of an user input, meta search extension 206 determines if the user input is associated with re-presenting the composite search results in a different sort order, e.g. by the returning search engines instead (as opposed to the composite relevance values), or if the user input is associated with the selection of a displayed search result (more specifically, a location identifier of a search criteria satisfying content), block 1102. If the user input is associated with re-presenting the composite search results in a different sort order, meta search extension 206 re-sorts and re-presents the merged search results accordingly, block 1104. On the other hand, if the user input is associated with retrieving the search criteria satisfying content corresponding to a selected search result (location identifier), meta search extension 206 retrieves the search criteria satisfying content, block 1106. For the illustrated embodiment, as a result of the “extension” approach to implementing meta search function, the retrieval operation is advantageously performed within the same context as the search queries.

In one embodiment, meta search extension 206 returns the retrieved contents for display in the main display pane of browser 204. Further, meta search extension 206 processes the retrieved contents to enhance their usability before passing on the contents for display. More specifically, in one embodiment, meta search extension 206 looks for occurrence of the search criteria in the retrieved content, and modifies their properties, before sending on the retrieved contents for display by browser 204 in its main display pane. The modifications are designed to cause the browser to highlight the search criteria when displaying the retrieved contents. In one embodiment, the retrieved contents are encoded using HTML, meta search extension 206 advantageously extracts the substantive contents, stores the extracted contents as a data object (thereby enabling the various associated properties of the data elements to be modifiable), and modifies the appropriate properties of the data objects, such that when provided with the data for display, browser 204 would highlight the occurrences of the search criteria as specified by the modified properties of the search crtieria.

Accordingly, it can be seen from the foregoing description, the retrieved search criteria satisfying contents are much more user friendly than the counterpart under the prior art.

### Example Computer System

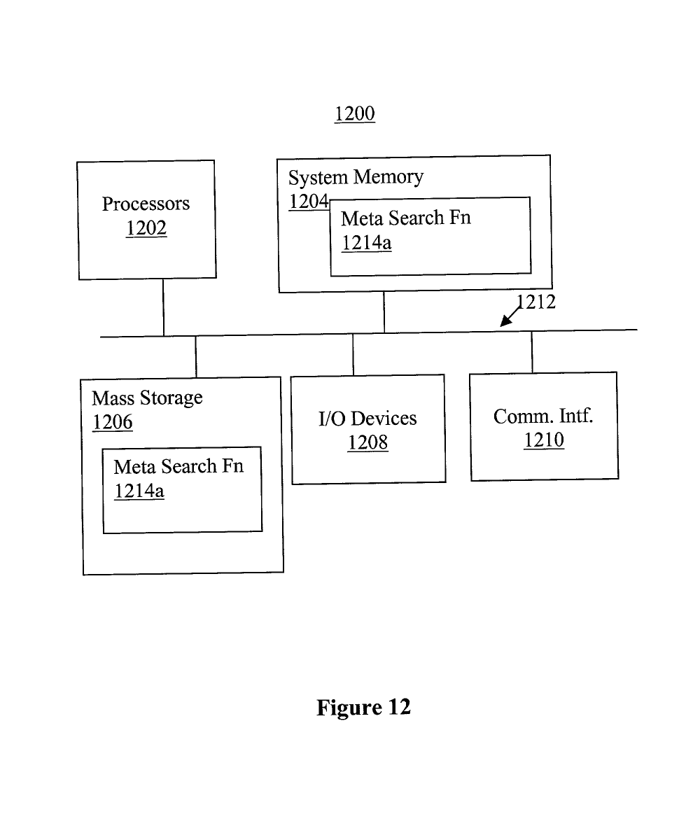

FIG. 12 illustrates an example computer system suitable for use as a server to host the meta search library or as a client computer, in accordance with one embodiment. As shown, computer system 1200 includes one or more processors 1202 and system memory 1204. Additionally, computer system 1200 includes mass storage devices 1206 (such as diskette, hard drive, CDROM and so forth), input/output devices 1208 (such as keyboard, cursor control and so forth) and communication interfaces 1210 (such as network interface cards, modems and so forth). The elements are coupled to each other via system bus 1212, which represents one or more buses. In the case of multiple buses, they are bridged by one or more bus bridges (not shown). Each of these elements performs its conventional functions known in the art. In particular, system memory 1204 and mass storage 1206 are employed to store a working copy and a permanent copy of the programming instructions implementing the meta search function and the search query/processing templates of the present invention. The constitution of these elements 1202-1212 are known, and accordingly will not be further described.

### Conclusion and Epilogue

Thus, it can be seen from the above descriptions, a novel method and apparatus for a client based approach to online content meta search has been described. The novel method/apparatus is advantageously scalable to support a very large number of client computers desiring online content meta searches, with increased usability for the users.

While the present invention has been described in terms of the above illustrated embodiments, those skilled in the art will recognize that the invention is not limited to the embodiments described. The present invention can be practiced with modification and alteration within the spirit and scope of the appended claims. The description is thus to be regarded as illustrative instead of restrictive on the present invention.

What is claimed is:

1. In a client computer, a method of operation comprising:
accepting into said client computer from an external source, a plurality of search query templates and a plurality of search result processing templates for a plurality of external search engines;
accepting into said client computer one or more search criteria;
transmitting from said client computer a plurality of search queries having said one or more search criteria, separately destined for at least a subset of said search engines, using selected ones of said search query templates;
receiving into said client computer search results separately returned from said search engines responsive to said search queries, using corresponding ones of said search result processing templates of said search result returning search engines; and
displaying on said client computer at least a selected/derived subset of said separately returned search results.

2. The method of claim 1, wherein said search query templates are correspondingly included in a plurality of definitions for said search engines, and said search query templates are accepted through acceptance into said client computer said plurality of definitions.

3. The method of claim 1, wherein each of said search engines is a member of one or more search category groups, said one or more search criteria are accepted for a selected one of said search category groups, and said search queries transmitted are destined for search engines that are member of the selected search category group for which said one or more search criteria are accepted.

4. The method of claim 1, wherein the method further comprises merging said returned search results into a composite set of search results, and computing a composite relevance value for each search result.

5. The method of claim 4, wherein each of said composite relevance computations includes giving weight to the particular search result in accordance with relevant weights given to the incidences of the particular search result by the returning search engines.

6. The method of claim 4, wherein each of said composite relevance computations includes giving weights to the particular search result based on the relative positions occupied by the incidences of the particular search result in the returned search result sets of the search engines.

7. The method of claim 4, wherein each of said composite relevance computations includes giving weight to the particular search result in accordance with at least one of the number of search engines returning the particular search result, and the number of exact occurrences of key search terms.

8. The method of claim 4, wherein said displaying comp rises displaying said composite set of search results in accordance with the computed composite relevance values.

9. The method of claim 1, wherein said search result processing templates are correspondingly included in a plurality of definitions for said search engines, and said search result processing templates are accepted through acceptance into said client computer said plurality of definitions.

10. The method of claim 1, wherein said search results are location identifications of contents satisfying said search criteria, and the method further comprises
retrieving into said client computer a selected one of said contents as a local data object in response to a user of said client computer selecting one of said displayed location identifications;
processing on said client computer the local data object of the retrieved content; and
displaying on said client computer the processed local data object of the retrieved content.

11. The method of claim 10, wherein said processing comprises modifying the local data object to highlight occurrences of said search criteria in said retrieved content.

12. In a client computer, a method of operation comprising:
accepting into said client computer one or more search criteria;
transmitting from said client computer a plurality of search queries having said one or more search criteria, separately destined for a plurality of search engines;
receiving into said client computer search results separately returned from said search engines responsive to said search queries;
merging on said client computer at least a selected subset of said received returned search results into a composite set of search results with no duplicates, including computing for each of said search results a composite relevance value; and
displaying on said client computer said composite set of search results in accordance with said computed composite relevance values.

13. The method of claim 12, wherein each of said search engines is a member of one or more search category groups, said one or more search criteria are accepted for a selected one of said search category groups, and said search queries transmitted are destined for search engines that are member of the selected search category group for which said one or more search criteria are accepted.

14. The method of claim 12, wherein each of said composite relevance computations includes giving weights to the particular search result in accordance with relevant weights given to the incidences of the particular search result by the returning search engines.

15. The method of claim 12, wherein each of said composite relevance computations includes giving weights to the particular search result based on the relative positions occupied by the incidences of the particular search result in returned search result sets of the search engines.

16. The method of claim 12, wherein each of said composite relevance computations includes giving weight to the particular search result in accordance with at least one of the number of search engines returning the particular search result, and the number of exact occurrences of key search terms.

17. The method of claim 12, wherein said search results are location identifications of contents satisfying said search criteria, and the method further comprises
retrieving into said client computer a selected one of said contents as a local data object in response to a user of said client computer selecting one of said displayed location identifications;
processing on said client computer the local data object of the retrieved content; and
displaying on said client computer the processed local data object of the retrieved content.

18. The method of claim 17, wherein said processing comprises modifying the local data object to highlight occurrences of said search criteria in said retrieved content.

19. In a client computer, a method of operation comprising:
assigning first weights, in accordance with a first heuristic factor, to a search result derived from search results returned by search engines;
assigning second weights, in accordance with a second heuristic factor, to the search result; and
computing a composite relevance value for the search result based at least in part on said assigned first and second weights.

20. The method of claim 19, wherein
said assignment of first weights in accordance with a first heuristic factor comprises assigning weights to the search result in accordance with relevant weights given to incidences of the search result by the returning search engines; and
said assignment of second weights in accordance with a second heuristic factor comprises assigning weights to the search result in accordance with the relative positions occupied by the incidences of the search result among the search results returned by the search engines.

21. The method of claim 19, wherein
said assignment of first weights in accordance with a first heuristic factor comprises assigning weights to the search result in accordance with relevant weights given to incidences of the search result by the returning search engines; and
said assignment of second weights in accordance with a second heuristic factor comprises assigning weights to the search result in accordance with the number of search engines returning incidences of the search result.

22. The method of claim 19, wherein
said assignment of first weights in accordance with a first heuristic factor comprises assigning weights to the search result in accordance with the relative positions occupied by the incidences of the search result among the search results returned by the search engines; and
said assignment of second weights in accordance with a second heuristic factor comprises assigning weights to the search result in accordance with the number of search engines returning incidences of the search result.

23. In a server computer, a method of operation comprising:
providing each of a plurality of client computers with a plurality of search query templates for a plurality of search engines for the client computers to selectively submit search queries directly to selected subsets of said search engines; and
providing each of the plurality of client computers with a plurality of search result processing templates for the plurality of search engines for the client computers to process search results returned by the search engines.

24. The method of claim 23, wherein both of said search query templates and said search result processing templates are part of corresponding definitions for the search engines, and said providing operations are performed jointly by providing each of said plurality of client computers with said definitions.

25. The method of claim 23, wherein the method further comprises providing to each of said client computers updates to or additional ones of said search query and result processing templates.

26. An apparatus comprising:
storage medium having stored therein a plurality of programming instructions designed to
accept into said apparatus from an external source, a plurality of search query templates and a plurality of search result processing templates for a plurality of external search engines,
accept into said apparatus one or more search criteria,
transmit from said apparatus a plurality of search queries having said one or more search criteria, separately destined for at least a subset of said search engines, using selected ones of said search query templates,
receive into said apparatus search results separately returned from said search engines responsive to said search queries, using corresponding ones of said search result processing templates, and
display on said apparatus at least a selected/derived subset of said separately returned search results; and
one or more processor coupled to the storage medium to execute the programming instructions.

27. The apparatus of claim 26, wherein said search query templates are correspondingly included in a plurality of definitions for said search engines, and said programming instructions are designed to accept said search query templates through acceptance into said apparatus said plurality of definitions.

28. The apparatus of claim 26, wherein each of said search engines is a member of one or more search category groups, said one or more search criteria are accepted for a selected one of said search category groups, and said search queries transmitted are destined for search engines that are member of the selected search category group for which said one or more search criteria are accepted.

29. The apparatus of claim 26, wherein the programming instructions are further designed to merge said returned search results into a composite set of search results with no duplicates, and compute a composite relevance value for each search result.

30. The apparatus of claim 29, wherein said programming instructions are designed to give weight to an search result in accordance with relevant weights given to the incidences of the search result by the returning search engines, when performing each of said composite relevance computations.

31. The apparatus of claim 29, wherein said programming instructions are further designed to give weights to an search result based on the relative positions occupied by the incidences of the search result in the returned search result sets of the search engines, when performing each of said composite relevance computations.

32. The apparatus of claim 29, wherein the programming instructions are further designed to give weight to an search result in accordance with at least one of the number of search engines returning the search result and the number of exact occurrences of key search terms, when performing each of said composite relevance computations.

33. The apparatus of claim 29, wherein said programming instructions are designed to perform said displaying by displaying said composite set of search results in accordance with the computed composite relevance values.

34. The apparatus of claim 26, wherein said search result processing templates are correspondingly included in a plurality of definitions for said search engines, and said programming instructions are designed to accept said search result processing templates through acceptance into said apparatus said plurality of definitions.

35. The apparatus of claim 26, wherein said search results are location identifications of contents satisfying said search criteria, and the programming instructions are further designed to
retrieve into said apparatus a selected one of said contents as a local data object in response to a user of said apparatus selecting one of said displayed location identifications;
processing on said apparatus the local data object of the retrieved content; and
displaying on said apparatus the processed local data object of the retrieved content.

36. The apparatus of claim 35, wherein said programming instructions are designed to perform said processing by modifying the local data object to highlight occurrences of said search criteria in said retrieved content.

37. An apparatus comprising:
storage medium having stored therein a plurality of programming instructions designed to
accept into said apparatus one or more search criteria;
transmit from said apparatus a plurality of search queries having said one or more search criteria, separately destined for a plurality of search engines;
receive into said apparatus search results separately returned from said search engines responsive to said search queries;
merge on said apparatus at least a selected subset of said received returned search results into a composite set of search results with no duplicates, including computing for each of said search result a relevance value; and
displaying on said apparatus said composite set of search results in accordance with said computed relevance values.

38. The apparatus of claim 37, wherein each of said search engines is a member of one or more search category groups, said one or more search criteria are accepted for a selected one of said search category groups, and said search queries transmitted are destined for search engines that are member of the selected search category group for which said one or more search criteria are accepted.

39. The apparatus of claim 37, wherein said programming instructions are designed to give weights to an search result in accordance with relevant weights given to the incidences of the search result by the returning search engines, when performing each of said composite relevance computations.

40. The apparatus of claim 37, wherein said programming instructions are designed to give weights to an search result based on the relative positions occupied by the incidences of the search result in returned search result sets of the search engines, when performing each of said composite relevance computations.

41. The apparatus of claim 37, wherein said programming instructions are further designed to give weights to an search result in accordance with at least one of the number of search engines returning the search result and the number of exact occurrences of key search terms, when performing each of said composite relevance computations.

42. The apparatus of claim 37, wherein said search results are location identifications of contents satisfying said search criteria, and the programming instructions are further designed to
retrieve into said apparatus a selected one of said contents as a local data object in response to a user of said apparatus selecting one of said displayed location identifications;
process on said apparatus the local data object of the retrieved content; and
display on said apparatus the processed local data object of the retrieved content.

43. The apparatus of claim 42, wherein said programming instructions are designed to perform said processing by modifying the local data object to highlight occurrences of said search criteria in said retrieved content.

44. An apparatus comprising:
storage medium having stored therein a plurality of programming instructions deigned to
assign first weights, in accordance with a first heuristic factor, to an search result derived from search results returned by search engines,
assign second weights, in accordance with a second heuristic factor, to the search result, and
to compute a composite relevance value for the search result based at least in part on said assigned first and second weights; and
at least one processor coupled to the storage medium to execute the programming instructions.

45. The apparatus of claim 44, wherein said programming instructions are designed to
assign said first weights in accordance with relevant weights given to incidences of the search result by the returning search engines, and
assign said second weights in accordance with the relative positions occupied by the incidences of the search result among the search results returned by the search engines.

46. The apparatus of claim 44, wherein said programming instructions are designed to
assign said first weights in accordance with relevant weights given to incidences of the search result by the returning search engines, and
assign said second weights in accordance with the number of search engines returning incidences of the search result.

47. The apparatus of claim 44, wherein said programming instructions are designed to
assign said first weights in accordance with the relative positions occupied by the incidences of the search result among the search results returned by the search engines, and
assign said second weights in accordance with the number of search engines returning incidences of the search result.

48. An apparatus comprising:
storage medium having stored therein a plurality of programming instructions designed to provide each of a plurality of client computers with
a plurality of search query templates for a plurality of search engines for the client computers to selectively submit search queries directly to selected subsets of said search engines, and
a plurality of search result processing templates for the plurality of search engines for the client computers to process search results returned by the search engines; and
one or more processors coupled to the storage medium to execute the programming instructions.

49. The apparatus of claim 48, wherein both of said search query templates and said search result processing templates are part of corresponding definitions for the search engines, and said programming instructions are designed to perform said provide operations by providing each of said plurality of client computers with said definitions.

50. The apparatus of claim 48, wherein the programming instructions are further designed to provide each of said client computers with updates or additional ones of said search query and result processing templates.
